(19) United States
(12) Patent Application Publication
(10) Pub. No.: US 2018/0237159 A1
(43) Pub. Date: Aug. 23, 2018

(54) Autonomous UAV Retrieval System

(71) Applicant: Wal-Mart Stores, Inc., Bentonville, AR (US)

(72) Inventors: Robert Cantrell, Herndon, VA (US); Donald High, Noel, MO (US); John Jeremiah O'Brien, Farmington, AR (US)

(21) Appl. No.: 15/882,084

(22) Filed: Jan. 29, 2018

Related U.S. Application Data
(60) Provisional application No. 62/460,313, filed on Feb. 17, 2017.

(51) Int. Cl. B64F 1/22; B64C 39/02; B64D 1/02; B60P 3/11

(52) U.S. Cl. CPC B64F 1/222; B64C 39/024; B64D 1/02; B60P 3/11; G06Q 50/28; B64C 2201/128; B64C 2201/182; B64C 2201/208; B64C 2201/141; B64C 2201/024

(57) ABSTRACT

Described in detail herein is an autonomous UAV retrieval system. The system includes a delivery motor vehicle including a retrieval opening, a fan, a vent and a storage container can generate a vacuum effect by controlling an operation of the fan and the vent. The retrieval opening can include a perforated top screen. A UAV can be received into the retrieval opening through the top screen in response to the UAV navigating to within a predetermined distance of the delivery motor vehicle. The UAV can including an inertial navigation system and one or more delivery mechanisms. The UAV can be guided, via a configuration of the retrieval into the storage container.

### CROSS-REFERENCE TO RELATED PATENT APPLICATIONS

This application claims priority to U.S. Provisional Application No. 62/460,313 filed on Feb. 17, 2017, the content of which is hereby incorporated by reference in its entirety.

### BACKGROUND

Unmanned Aerial Vehicles (UAVs) can be used delivery physical objects. The UAVs are retrieved following delivery of the physical objects.

### SUMMARY

In one embodiment, an unmanned aerial vehicle (UAV) retrieval system can include, an autonomous UAV that includes an inertial navigation system and one or more delivery mechanisms, the autonomous UAV configured to autonomously navigate aerially and a delivery motor vehicle. The delivery motor vehicle can include a retrieval opening located on top of the delivery motor vehicle, a fan disposed with respect to the retrieval opening, a vent disposed with respect to the retrieval opening, and a storage container disposed at a base of the retrieval opening. The delivery motor vehicle is configured to generate a vacuum effect by controlling an operation of the fan and the vent so as to draw the autonomous UAV into the retrieval opening in response to the autonomous UAV navigating to within a predetermined distance of the delivery motor vehicle, a configuration of the retrieval opening guiding the autonomous UAVs into the storage container.

In one embodiment, a delivery motor vehicle includes a retrieval opening located on top of the delivery motor vehicle, a fan disposed with respect to the retrieval opening, a vent disposed with respect to the retrieval opening, and a storage container disposed at a base of the retrieval opening. The delivery motor vehicle is configured to generate a vacuum effect by controlling an operation of the fan and the vent so as to draw at least one autonomous UAV into the retrieval opening in response to the at least one autonomous UAV navigating to within a predetermined distance of the delivery motor vehicle, a configuration of the retrieval opening guiding the at least one physical object into the storage container.

In one embodiment, a UAV retrieval method includes generating, in a delivery motor vehicle that includes a retrieval opening located on top of the delivery motor vehicle, a vacuum effect by controlling operation of a fan and a vent disposed with respect to the retrieval opening t. The method further includes receiving, via operation of the vacuum effect, at least one autonomous UAV into the retrieval opening in response to the at least one autonomous UAV navigating to within a predetermined distance of the delivery motor vehicle, the at least one autonomous UAV including an inertial navigation system and one or more delivery mechanisms. The method further includes guiding, via a configuration of the retrieval opening the at least one of the autonomous UAVs into a storage container disposed at a base of the retrieval opening.

### BRIEF DESCRIPTION OF DRAWINGS

Illustrative embodiments are shown by way of example in the accompanying drawings and should not be considered as a limitation of the present disclosure:

FIG. 1A is a block diagram illustrating an unmanned aerial vehicle (UAV) according to an exemplary embodiment;

FIG. 1B is a block diagrams illustrating the launching of the UAV according to an exemplary embodiment;

FIG. 1C illustrates a folded UAV according to an exemplary embodiment;

FIG. 1D illustrates a UAV retrieval system according to an exemplary embodiment;

FIG. 2 is a block diagram illustrating an automated UAV system according to an exemplary embodiment;

FIG. 3 is a block diagram illustrating an exemplary computing device suitable for use in an exemplary embodiment; and

FIG. 4 is a flowchart illustrating an exemplary process of an automated UAV retrieval system in accordance with an exemplary embodiment;

### DETAILED DESCRIPTION

Described in detail herein is an automated UAV retrieval system that includes a delivery motor vehicle having a retrieval opening, a fan, a vent and a storage container. The delivery motor vehicle can generate a vacuum effect by controlling an operation of the fan and the vent. The retrieval opening can include a perforated top screen. Through the use of the vacuum effect, a UAV can be received into the retrieval opening in response to the UAV navigating to within a predetermined distance of the delivery motor vehicle. The UAV can include an inertial navigation system and one or more delivery mechanisms. The UAV can be guided, via a configuration of the retrieval opening into the storage container.

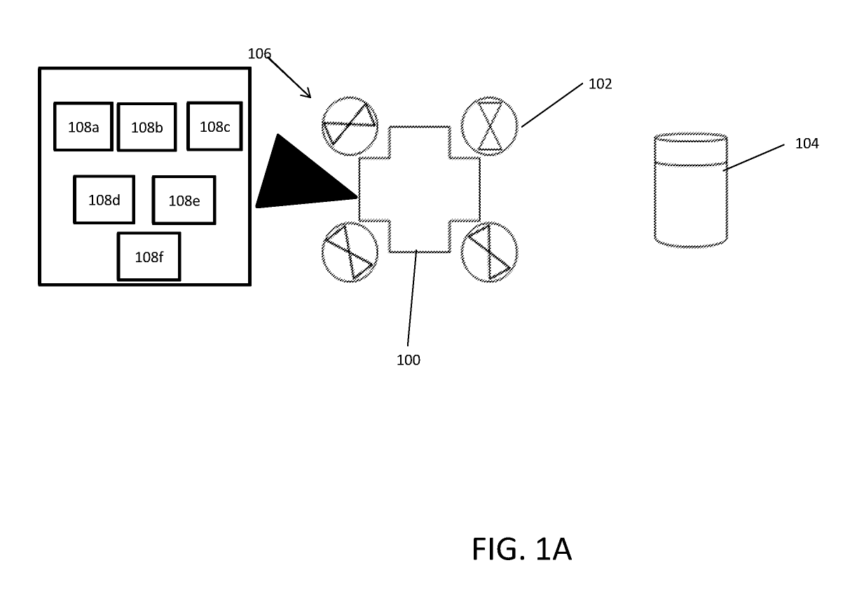

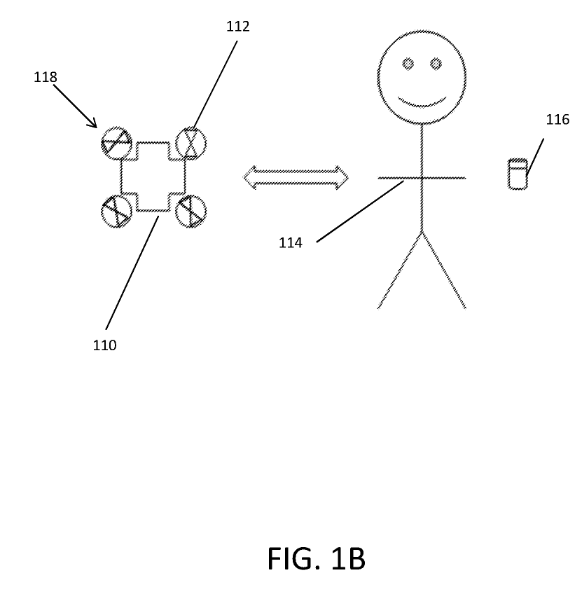

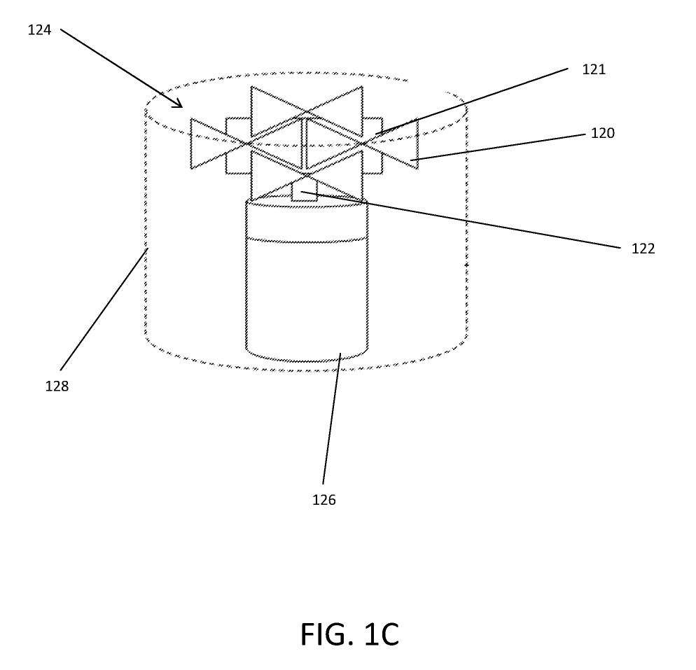

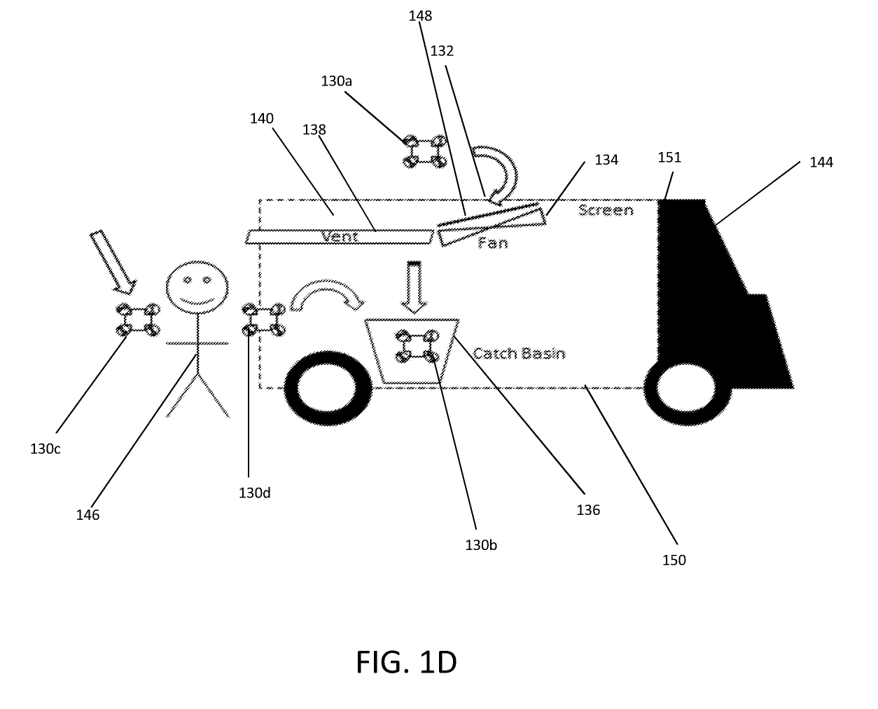

FIG. 1A is a block diagram illustrating an unmanned aerial vehicle (UAV) according to an exemplary embodiment. In one embodiment the autonomous UAV 106 can include an inertial navigation system and one or more delivery mechanisms. The autonomous UAV 106 can autonomously navigate aerially using motive assemblies 102. The motive assemblies 102 can be but are not limited to wheels, tracks, rotors, rotors with blades, and propellers. The UAV 106 can include a body 100 and multiple motive assemblies 102. In this non-limiting example, the motive assemblies can be secured to the body on the edges of the UAV 106.

The body 100 of the UAV 106 can include a delivery mechanism. The delivery mechanism can be a picking unit (not shown) such as electrically operated clamps, claw-type clips, hooks, electro-magnets or other types of grasping mechanisms. The UAV can include a controller 108a, and the inertial navigation system can include a GPS receiver 108b, accelerometer 108c and a gyroscope 108d. The UAV 106 can also include a motor 108e. The controller 108a can be programmed to control the operation of the GPS receiver 108b, accelerometer 108c, a gyroscope 108d, motor 108e, and drive assemblies 102 (e.g., via the motor 108e), in response to various inputs including inputs from the GPS receiver 108b, the accelerometer 108c, and the gyroscope 108d. The motor 108e can control the operation of the motive assemblies 102 directly and/or through one or more drive trains (e.g., gear assemblies and/or belts).

The GPS receiver 108b can be a L-band radio processor capable of solving the navigation equations in order to determine a position of the UAV 106, determine a velocity and precise time (PVT) by processing the signal broadcasted by GPS satellites. The accelerometer 180c and gyroscope 108d can determine the direction, orientation, position, acceleration, velocity, tilt, pitch, yaw, and roll of the UAV 106. In exemplary embodiments, the controller can implement one or more algorithms, such as a Kalman filter, for determining a position of the UAV.

The UAV 106 can be of a reduced size and configured to pick up physical objects 104 of reduced size (e.g. a pill bottle) using the picking unit. The UAV 106 can be proportionate to the size of the physical object 104. The UAV 106 can pick up and carry the physical object 104 to a predetermined location. In some embodiments, multiple UAVs can be configured to pick up a portion of a physical object and carry the physical object together, to a pre-determined location. In one embodiment, multiple UAVs 106 may combine to carry a frame with an attached delivery mechanism. The frame may be configured to be attached to multiple autonomous UAVs configured to launch from the delivery motor vehicle. The attached delivery mechanism of the frame may be configured to be attached to a physical object to be delivered.

In one embodiment, the UAV may be further equipped with a communication interface 108f enabling short or long range communication with a computing device. For example, as a non-limiting example, the UAV 106 may be capable of communicating over either or both of a Bluetooth® or WiFi communication link to a computing device located onboard the delivery motor vehicle. As further explained below, the communication interface may be utilized to trigger an automatic retrieval of the UAV 106 by a delivery motor vehicle.

FIG. 1B is a block diagram illustrating the launching of the UAV according to an exemplary embodiment. In a non-limiting example, the UAV 118 including a body, and motive assemblies 112 can be grasped by a user's 114 hand. The UAV 118 can including a picking unit (not shown) configured to pick up and carry a physical object 116. The user can grasp the UAV 118 and unsecure the physical object 116 from the picking unit. Conversely, the user can secure a physical object 116 to the picking unit of the UAV 118, power on the UAV 118. Power can be transferred to the motive assemblies 112 and the UAV can aerially navigate using the motive assemblies 112. In one embodiment, the user 114 may launch the UAV from a delivery motor vehicle.

FIG. 1C illustrates a folded UAV according to an exemplary embodiment. In a stationary position, the UAV 124 can be compressed and stored inside a container 128. The UAV 124 can include motive assemblies 120, a frame 121 and a picking unit 122. A physical object 126 can be secured to the picking unit 122. The frame 121 and/or the motive assemblies can be made of flexible material. The motive assemblies 120 and/or body 121 can be folded into a compressed state. Subsequently, the UAV 118 can be placed inside the container 128. The container can be used to transport the UAV 118 in a delivery motor vehicle and/or store the UAV 118 in the delivery motor vehicle.

FIG. 1D illustrates an automated UAV retrieval system according to an exemplary embodiment. The automated UAV retrieval system includes a delivery motor vehicle 144 and multiple UAVs 130a-d. The delivery motor vehicle 144 can include a retrieval opening 140 located at the top of the delivery motor vehicle. In one embodiment, the retrieval opening 140 can include a top perforated screen 132. The delivery motor vehicle 144 may include a base 150, a side wall 151 towards the front of the delivery motor vehicle 144, and a door (not shown) towards the back of the delivery motor vehicle. The door can provide access to the interior of the delivery motor vehicle 144. The delivery motor vehicle 144 can further include a fan 134, a vent 138 and a storage container 136. The fan 124 and vent 138 can be disposed near the retrieval opening 140 and the storage container 136 can be disposed below (at a base of) the retrieval opening 140.

In one embodiment, the delivery motor vehicle 144 can control operation of the fan 134 and the vent 138 so as to create a vacuum effect that works to draw the UAV 106 into the delivery motor vehicle during a retrieval process. In more detail, the fan 134 can operate at a specified speed and the vent opening can be controlled to create a vacuum effect near the top of the retrieval opening 140. The fan 134 can be a device to produce a flow of air. The fan 134 can include propellers, rotors, and/or blades operating at a specified speed to produce the flow of air. The opening of the vent 138 can be adjustable to allow differing amounts of the air into the delivery motor vehicle. For example, the vent may have one or more slats whose position dictates the amount of air intake. The vent may attached to a controller. The fan 134 and vent 138 may be communicatively coupled to, and controllable by a computing device on the delivery vehicle, and in combination can operate to create a vacuum effect (i.e. a suction effect) to assist in UAV retrieval. The vent 138 and fan 134 can be electronically powered through a power source located on or about the delivery motor vehicle 144. The vent 138 and fan 134 can be powered on automatically when the delivery motor vehicle 134 is powered on. Alternatively, the vent 138 and the fan 134 can be selectively powered on.

After a delivery, the UAV 130a can navigate aerially toward the top of the delivery motor vehicle 144. The UAV 130a can be pulled toward the retrieval opening by the generated vacuum effect. The UAV 130a can be pulled through the retrieval opening. In one embodiment, the retrieval opening may include a perforated screen and the UAV may land on the screen to slow its descent before entering the interior of the delivery motor vehicle through the perforation. A cover 148 can be placed on top of the fan 134 to prevent the UAV 130a from being pulled into the fan 134. The UAV 130a can be guided by the air flow created by the fan 134 and the vent 138 within the retrieval opening 140 into the storage container 136. The storage container 136 can be configured to receive the UAVs, as shown by the UAV 130b. In one embodiment, the delivery motor vehicle may also include a chute located below the retrieval opening which assists in guiding the UAV to the storage container 136. In an embodiment, the chute may be padded.

In an embodiment, the autonomous UAV may communicate with a computing device on the delivery motor vehicle when the autonomous UAV comes within a predetermined distance of the delivery motor vehicle. The communication may trigger a programmatic initiation of the control of the fan and vent to create the vacuum effect to assist retrieval of the UAV. For example, in a UAV equipped with a Bluetooth® capability, a Bluetooth® receiver on the delivery motor vehicle may detect a signal from the UAV and the receipt of the signal may trigger the computing device on the delivery motor vehicle to control the fan and vent to initiate a vacuum effect as described above to assist in UAV retrieval. It will be appreciated that other forms of communication other than Bluetooth® may also take place between the UAV and the delivery motor vehicle that can act to trigger a programmatic initiation of the control of the fan and vent to create the vacuum effect to assist retrieval of the UAV without departing from the scope of the present invention.

In another embodiment, instead of a programmatic initiation, control of the fan and vent to create the vacuum effect may be manually triggered by an individual on the delivery motor vehicle upon visually identifying the UAV returning after a delivery. Alternatively, the fan and vent may be controlled so as to create the vacuum effect without first identifying a returning UAV, for example, by always creating the effect whenever the delivery motor vehicle is operating or whenever power is supplied to the fan.

In some embodiments, a user 146 can deposit the UAVs 130c-d, by hand into the retrieval opening 140. The UAVs 130c-d can be guided by the operation of the fan 134 and the vent 138 into the storage container 136.

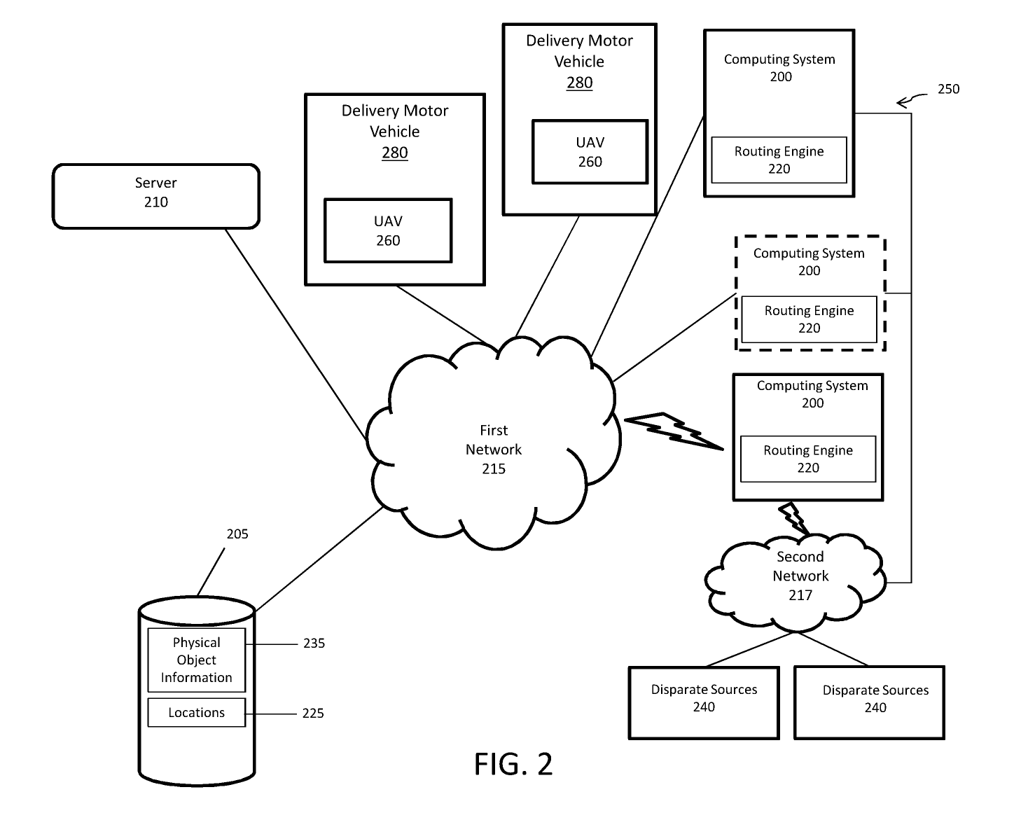

FIG. 2 is a block diagram illustrating an automated UAV system according to an exemplary embodiment. The automated UAV system 250 can include one or more databases 205, one or more servers 210, one or more computing devices 200, one or more disparate sources 240, and UAVs 260 in a delivery motor vehicle 280. Computing device 200 may be located onboard a delivery motor vehicle 280. In exemplary embodiments, the computing device 200 can be in communication with the databases 205, the server(s) 210, and the UAVs 260, via a first communications network 215. The disparate sources 240 can be in communication with the computing device 200, via the second communications network 217. The computing device 200 can implement at least one instance of a routing engine 220.

In an example embodiment, one or more portions of the first and second communications network 215 and 217 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing device 200 includes one or more processors configured to communicate with the databases 205 and UAVs 260 via the first network 215. The computing device 200 hosts one or more applications configured to interact with one or more components of the automated UAV system 250. The databases 205 may store information/data, as described herein. For example, the databases 205 can include a locations database 225, physical objects database 230. The locations database 225 can include information associated with addresses and/or GPS coordinates of delivery locations. The physical objects database 230 can store information associated with physical objects. The databases 205 and server 210 can be located at one or more geographically distributed locations from each other or from the computing device 200. Alternatively, the databases 205 can be included within server 210 or computing device 200.

In exemplary embodiments, computing device 200 can receive instructions to retrieve one or more physical objects from a facility. The computing device 200 can execute the routing engine 220 in response to receiving the instructions. The instructions can include identifiers associated with the physical objects and a delivery location. The routing engine 220 can query the physical objects database 235 to retrieve the locations of the physical objects in the facility using the identifiers. The physical objects can be retrieved and can be loaded onto the delivery mechanisms of one or more UAVs 260. In some embodiments, the routing engine 220 can instruct one or more UAVs 260 to navigate to the locations of the physical objects and to retrieve the physical objects from the facility. The routing engine 220 can query a locations database 225 to determine the GPS coordinates associated with the delivery location received in the instructions.

The routing engine 220 can transmit instructions to the UAVs 260 to navigate to a specified location based on the GPS coordinates and to deposit the physical object loaded onto the UAV 260 at the specified location. The instructions can also include a location to which the UAV 260 should navigate back to once the physical object has been deposited The UAVs 260 can be powered off and loaded onto a delivery motor vehicle. Alternatively, the UAVs 260 can be placed in a hibernation state. The delivery motor vehicle can include multiple UAVs instructed to delivery physical objects within a specified threshold distance of each other. The delivery motor vehicle navigate to a location within a predetermined threshold distance of the delivery locations instructed to the UAVs 260 loaded in the delivery motor vehicle.

The UAVs 260 can be unloaded from the delivery motor vehicle and can be powered on. The UAVs 260 can navigate to the instructed delivery location based on the GPS coordinates, deposit the physical object at the delivery location and navigate back to the delivery motor vehicle. The UAVs 260 can be instructed to navigate to a predetermined distance of the delivery motor vehicle. The UAVs 260 can be retrieved using the automated UAV retrieval system described herein.

As a further non-limiting example, the automated UAV system 250 can be implemented in a retail store. The computing device 200 can receive instructions from disparate sources 240 to retrieve and deliver products from a retail store. The disparate sources 240 can be customers purchasing products and requesting delivery of the products to a specified address. The instructions can include the identifiers of the products and the delivery address. The computing device 200 can execute the routing engine 220 in response to receiving the instructions. The routing engine 220 can query the physical objects database 235 to retrieve the locations of the products in the retail store. The products can be retrieved and loaded onto the delivery mechanisms of the UAVs 260. Alternatively, the routing engine 220 can instruct the UAVs 260 to autonomously navigate to the locations of the products and retrieve the products.

The routing engine 220 may transmit instructions to the UAVs 260 to deliver a product which has been loaded onto the UAVs 260 to a specified location based on the GPS coordinates. The routing engine 220 can also instruct the UAVs 260 to navigate back to the delivery motor vehicle after depositing the product at the delivery location. The delivery motor vehicle can include multiple UAVs instructed to deliver products within a specified threshold distance of each other. The delivery motor vehicle can navigate to a particular location within a predetermined threshold distance of the delivery locations of the UAVs 260. The UAVs can be powered on and unloaded from the delivery motor vehicle. The UAVs 260 can navigate to the delivery location and deposit the product to the instructed delivery location and navigate back to the delivery motor vehicle. The UAVs 260 can be retrieved back into the delivery motor vehicle as described herein.

As a further non-limiting example, the automated UAV system 250 can be implemented in a retail store. The computing device 200 can receive instructions from within the retail store to retrieve and deliver products from warehouse/storage location of the retail store to a different location at the retail store (i.e. to a customer in the retail store). The instructions can include the location within the retail store. The instructions can include the identifiers of the products and the delivery address. The computing device 200 can execute the routing engine 220 in response to receiving the instructions. The routing engine 220 can query the physical objects database 235 to retrieve the locations of the products in the retail store. The products can be retrieved and loaded onto the delivery mechanisms of the UAVs 260. Alternatively, the routing engine 220 can instruct the UAVs 260 to autonomously navigate to the locations of the products and retrieve the products. A bin (not shown) can be disposed in the warehouse/storage location of the retail store. The UAVs 260 can be guided by creating a vacuum

The routing engine 220 may transmit instructions to the UAVs 260 to deliver a product which has been loaded onto the UAVs 260 to a specified location within the retail store. The UAV 260 can navigate to the location within the retail store and unload the products. In one embodiment, the UAV 260 can use an internal localization grid to navigate in the retail store. The UAV 260 can unload the product at a desired location such as, but not limited to, in a shopping cart, in a person's hands, or in a bin/storage container. The routing engine 220 can also instruct the UAV 260 to navigate back to the warehouse/storage location of the retail store. A bin/storage container and a fan can be disposed in the warehouse/storage location of the retail store. The UAV 260 can be guided by the air flow created by the fan into the bin/storage container.

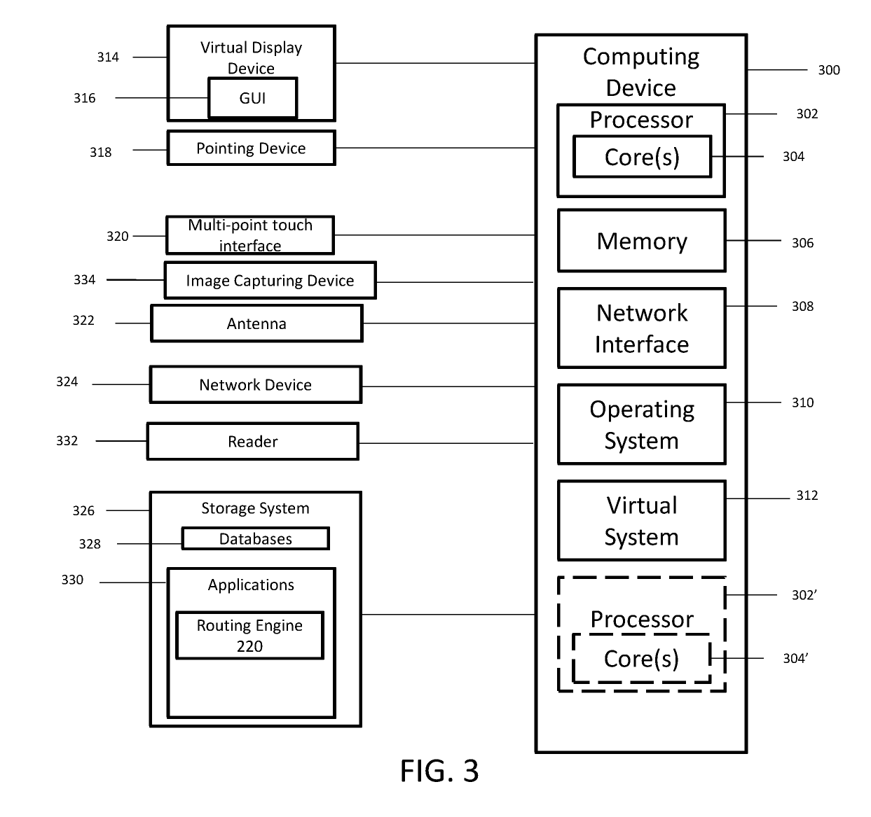

FIG. 3 is a block diagram of an exemplary computing device suitable for use in an embodiment. Computing device 300 can execute routing engine 220. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 such as the routing engine 220) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 314, such as a computer monitor, which may display one or more graphical user interfaces 316, multi touch interface 320, a pointing device 318, an image capturing device 334 and an reader 332.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information associated with physical objects disposed at a facility and can be indexed via the decoded identifier retrieved by the identifier reader and information associated with delivery locations. The databases 328 may be updated manually or automatically at any suitable time to add, delete, and/or update one or more data items in the databases.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

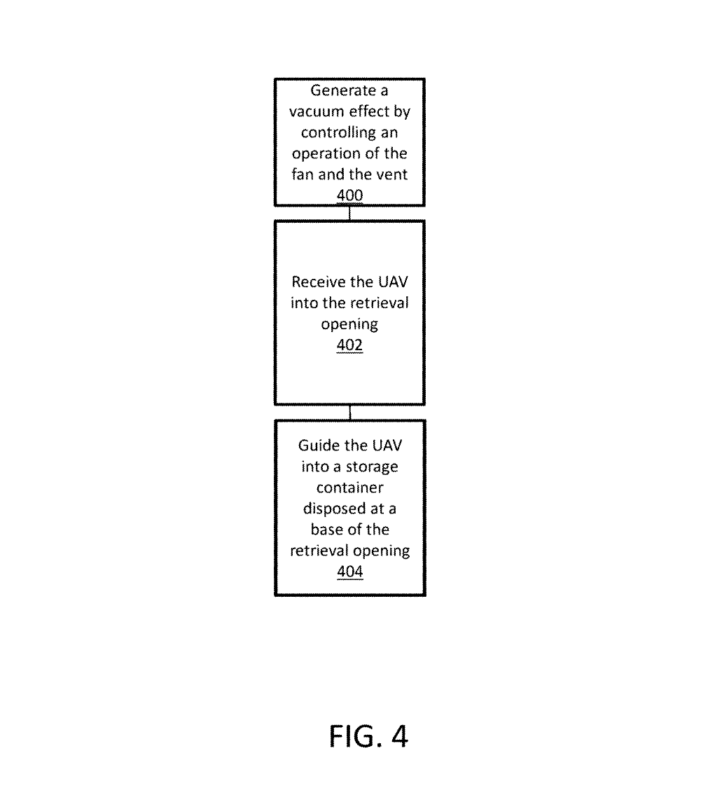

FIG. 4 is a flowchart illustrating an exemplary process of an automated UAV retrieval system in accordance with an exemplary embodiment. In operation 400, a delivery motor vehicle (e.g. delivery motor vehicle 144 as shown in FIG. 1D) including a retrieval opening (e.g. retrieval opening 140 as shown in FIG. 1D), a fan (e.g. fan 134 as shown in FIG. 1D), a vent (e.g. vent 138 as shown in FIG. 1D) and a storage container (e.g. storage container 136 as shown in FIG. 1D) can generate a vacuum effect by controlling an operation of the fan and the vent. In operation 402, a UAV (e.g. UAV 100, 110, 124, 130a-d and 260 as shown in FIGS. 1A-2) can be received into the retrieval opening through the top screen in response to the UAV navigating to within a predetermined distance of the delivery motor vehicle. In operation 404, the UAV can be guided into a storage container disposed at a base of the retrieval opening.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An unmanned aerial vehicle (UAV) retrieval system comprising:
an autonomous UAV that includes an inertial navigation system and one or more delivery mechanisms, the autonomous UAV configured to autonomously navigate aerially; and
a delivery motor vehicle including:
a retrieval opening located on top of the delivery motor vehicle,
a fan disposed with respect to the retrieval opening,
a vent disposed with respect to the retrieval opening, and
a storage container disposed at a base of the retrieval opening, wherein the delivery motor vehicle is configured to generate a vacuum effect by controlling an operation of the fan and the vent so as to draw the autonomous UAV into the retrieval opening in response to the autonomous UAV navigating to within a predetermined distance of the delivery motor vehicle, a configuration of the retrieval opening guiding the autonomous UAVs into the storage container.

2. The system of claim 1 wherein the retrieval opening has a perforated screen.

3. The system of claim 1 wherein the autonomous UAV communicates with a computing device on the delivery motor vehicle when the autonomous UAV comes within the predetermined distance of the delivery motor vehicle, the communication triggering a programmatic initiation of the control of the fan and vent to create the vacuum effect.

4. The system of claim 1 wherein control of the fan and vent to create the vacuum effect is manually triggered by an individual on the delivery motor vehicle.

5. The system of claim 1 wherein the one or more delivery mechanisms include at least one of an electrically operated clamp, a claw-type clip, a hook and at least one electro-magnet.

6. The system of claim 1, wherein the autonomous UAV is made of foldable material configured to fold into a compressed state.

7. The system of claim 1, wherein the autonomous UAV can carry one or more physical objects using the one or more delivery mechanisms and the autonomous UAV is configured to:
launch from the delivery motor vehicle,
navigate aerially and transport the one or more physical objects to a specified location using the inertial navigation system, and
deposit the one or more physical objects at the specified location.

8. The system of claim 7, wherein the autonomous UAV is further configured to:
navigate aerially in the direction of the delivery motor vehicle, in response to depositing the one or more physical objects at the specified location.

9. The system of claim 1, wherein the fan is disposed within a predetermined distance of the vent and the delivery motor vehicle generates the vacuum effect by controlling the fan to operate in a specified direction to generate air pressure and controlling the vent to pull in the air pressure.

10. The system of claim 1 wherein the autonomous UAV is a foot or less in diameter.

11. The system of claim 1, further comprising:
a frame including a delivery mechanism, the frame configured to be attached to a plurality of autonomous UAVs configured to launch from the delivery motor vehicle and the delivery mechanism of the frame is configured to be attached to a physical object to be delivered, wherein the plurality of autonomous UAVs attached to the frame operate together to aerially transport the physical object to be delivered.

12. A delivery motor vehicle, comprising:
a retrieval opening located on top of the delivery motor vehicle,
a fan disposed with respect to the retrieval opening,
a vent disposed with respect to the retrieval opening, and
a storage container disposed at a base of the retrieval opening, wherein the delivery motor vehicle is configured to generate a vacuum effect by controlling an operation of the fan and the vent so as to draw at least one autonomous UAV into the retrieval opening in response to the at least one autonomous UAV navigating to within a predetermined distance of the delivery motor vehicle, a configuration of the retrieval opening guiding the at least one physical object into the storage container.

13. The system of claim 12 wherein the autonomous UAV communicates with a computing device on the delivery motor vehicle when the autonomous UAV comes within the predetermined distance of the delivery motor vehicle, the communication triggering a programmatic initiation of the control of the fan and vent to create the vacuum effect.

14. An unmanned aerial vehicle (UAV) retrieval method comprising:
generating, in a delivery motor vehicle that includes a retrieval opening, a vacuum effect by controlling an operation of a fan and a vent disposed with respect to the retrieval opening located on top of the delivery motor vehicle;
receiving, via operation of the vacuum effect, at least one autonomous UAV into the retrieval opening in response to the at least one autonomous UAV navigating to within a predetermined distance of the delivery motor vehicle, the at least one autonomous UAV including an inertial navigation system and one or more delivery mechanisms; and
guiding, via a configuration of the retrieval opening the at least one of the autonomous UAVs into a storage container disposed at a base of the retrieval opening.

15. The method of claim 14, wherein the at least one autonomous UAV launch from the delivery motor vehicle and can carry one or more physical objects using one or more delivery mechanisms and the one or more physical objects are proportionate to the size of the at least autonomous UAV.

16. The method of claim 15, further comprising:
navigating the at least one autonomous UAV and aerially transporting the one or more physical objects to a specified location using the inertial navigation system, and
depositing the one or more physical objects at the specified location from the at least one autonomous UAV.

17. The method of claim 16, further comprising:
navigating the at least one autonomous UAV aerially in the direction of the delivery motor vehicle after depositing the one or more physical objects at the specified location.

18. The method of claim 14, wherein the fan is disposed within a predetermined distance of the vent and the delivery motor vehicle generates the vacuum effect by controlling the fan to operate in a specified direction to generate air pressure and controlling the vent to pull in the air pressure.

19. The method of claim 14, wherein the at least one autonomous UAV is a foot or less in diameter.

20. The method of claim 14, further comprising:
operating a plurality of autonomous UAVs that launch from the delivery motor vehicle and are attached to a frame that includes a delivery mechanism attached to a physical object to be delivered, so as to aerially transport the physical object to be delivered.
